(19) United States
(12) Patent Application Publication
(10) Pub. No.: US 2008/0032712 A1
(43) Pub. Date: Feb. 7, 2008

(54) Determining movement context of a mobile user terminal in a wireless telecommunications network

(76) Inventors: Jeroen van Bemmel, Leiden (NL); Jacco Brok, Enschede (NL)

Correspondence Address: Lucent Technologies Inc.;Docket Administrator, Room 3J-219, 101 Crawfords Corner Road, Holmdel, NJ, 07733-3030, US

(21) Appl. No.: 11/498,653

(22) Filed: Aug. 3, 2006

(51) Int. Cl. H04Q 7/20

(52) U.S. Cl. 455/456.6; 455/441

(57) ABSTRACT

A method is provided of determining the movement context of a mobile user terminal in a wireless telecommunications network by the steps of: determining a time at which transfer to a first cell occurs, determining a time at which transfer from said first cell first subsequently occurs, determining the difference between the two times, and assigning a movement context to the mobile user terminal, said context being dependent upon said difference.

### FIELD OF THE INVENTION

The present invention relates to telecommunications, in particular to wireless telecommunications.

### DESCRIPTION OF THE RELATED ART

There are trends in wireless telecommunications towards personalising services to particular users. There are also trends towards automating services, in particular enhanced services, such as transaction services, alarm monitoring, and voicemail. One aspect is the use of presence information that describes the current state and willingness of the user to engage in communications. Presence information can include context information about user movement, such as “at home”, “travelling”, or “driving”. By being provided with such information about a target user to be called, a caller is able to make an informed decision on when and how to call. For example, if the caller finds that the target user to be called is currently travelling in a car, he may decide not to make a voice call to the user.

Session Initiation Protocol, SIP, is a well-established standard in the technical area of automated enhanced services. SIP is an International Engineering Task Force, IETF, standard, defined by several IETF Requests For Comments, in particular RFC3261 and RFC3863. RFC3863 defines the use of SIP for presence extensions. Presence extensions describe the location of a user, and the context of the user, namely whether he/she is at home, driving or whatever.

According to this known approach, it is typically users who manually enter or select information about their locations and type of movement. Such entering or updating of location and context information is tedious so often users fail to do this. In consequence, at any time much of such information is obsolete. Manually entered context information is usually accurate initially, but ages quickly.

These problems have led to a desire to automatically determine context information as to the type of movement of a user to be called. One approach has been to use information as to in which cell of a wireless telecommunications network is currently located, namely cell identity, in order to identify the location of the mobile terminal from which context information can be deduced, e.g. “at home”. This can be done at the occurrence of an event, such as a call set-up. Such methods of relating cell identity to context can be by direct relation of cell identity and context, or indirectly, by using cell identity to provide geographic location information such as map coordinates, and from that information deducing context information regarding that user. In wireless networks, such as Universal Mobile Telecommunications System (UMTS) networks, or Code Division Multiple Access 2000, CDMA2000, networks, cell sizes are typically large, up to approximately 5 kilometres in diameter. This means that, in such networks, user location based on cell identity (often referred to as cell-id) provides little accuracy so context information might similarly be rough and inaccurate. On the other hand, in WiFi (IEEE 802.11) networks, as cells are smaller, accuracy in identifying location by way of cell-id is much better. Typically, location is known to an accuracy of tens to hundreds of metres. However as there are many small-scale WiFi networks, gathering and processing information on location is more involved.

In addition to location information, speed of movement is also useful in determining context information. User terminals are known that includes Global Positioning System, GPS, detectors that allow speed of the mobile terminal to be monitored. An estimate of speed provides context information, e.g. stationary (“at home”) when speed is less than 5 kilometres per hour (Km/h); “travelling” when the detected speed is greater than 5 Km/h but less than say, 50 Km/h; and “driving” when the speed is greater than, say, 50 Km/h. Such information is useful in selecting appropriate enhanced service offerings. For example, context information indicating “driving” might be taken as an indication that the user is a driver and hence an adult in deciding whether to send to that user a particular message relating to an enhanced service.

Use of GPS detectors in mobile terminals has disadvantages, not least in that GPS detectors require significant battery power and do not operate when line-of-sight from the mobile terminal to several GPS satellites is broken such as if the mobile terminal is indoors or is carried in a pocket or bag. Moreover, at the time of writing only a small percentage of mobile terminals on the market include a built-in GPS detector.

In this document the term handover is used to refer to transfer of a mobile terminal from one cell to another. A handover is the same as a handoff.

### SUMMARY OF THE INVENTION

The inventors found a way to provide useful context information relating to movement of a user by estimating speed of movement from the times when handover from one cell to another occurs.

An example of the present invention is a method of determining a movement context of a mobile user terminal in a wireless telecommunications network. The method is by the steps of: determining a time at which transfer to a first cell occurs, determining a time at which transfer from said first cell first subsequently occurs, determining the difference between the two times, and assigning a movement context to the mobile user terminal, said context being dependent upon said difference.

Another example is a mobile user terminal for wireless telecommunications. The terminal comprises a cell change detector operative to provide information of the times at which the mobile user terminal handovers from one cell to another. The terminal also comprises a processor operative to determining the difference between times of handovers into then out-of a cell. The terminal also comprises a movement context estimator operative to assign a movement context to the mobile user terminal, said context being dependent upon said difference.

### BRIEF DESCRIPTION OF THE DRAWINGS

Embodiments of the present invention will now be described by way of example and with reference to the drawings, in which:

FIG. 1 is a schematic diagram illustrating an example wireless telecommunications network and a user terminal according to an embodiment of the present invention,

FIG. 2 is a schematic diagram illustrating a mobile terminal according to a first embodiment of the invention, and

FIG. 3 is a schematic diagram illustrating a mobile terminal according to a second embodiment of the invention.

### DETAILED DESCRIPTION

From considering a known system, the inventor realised that context information relating to movement can be derived from considering the timing of a handover from one cell to another.

### Example Network

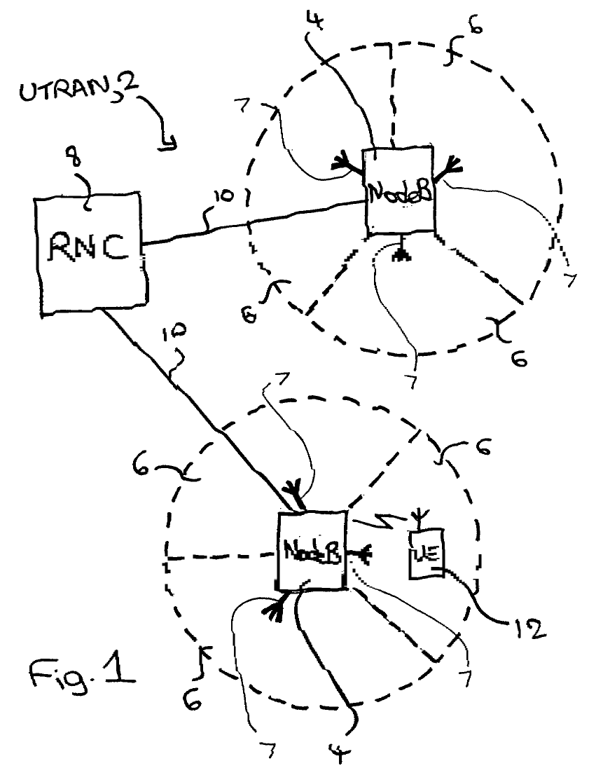

The example network is a Universal Mobile Telecommunications System (UMTS) terrestrial access network (UTRAN), which is a type of wideband code division multiple access (CDMA) network for mobile telecommunications. The UTRAN network is basically as shown in FIG. 1. Only one radio network controller and two base stations of the UTRAN network 2 are shown for simplicity. As shown in this Figure, the UTRAN network 2 includes base stations 4. In the Figure, each of the base stations 4 is also designated “Node B” in accordance with UMTS terminology. A cell, also referred to as a sector, is the radio-coverage area served by a corresponding antenna of a base station. Each base station typically has three cells 6, each covered by one of three directional antennas 7 angled at 120 degrees to each other in azimuth. Each radio network controller (RNC) 8 typically controls several base stations 4 and hence a number of cells 6. A base station 4 is connected to its controlling radio network controller (RNC) 8 via a respective interface 10 known as an IuB interface. In use, a mobile user terminal 12 (often referred to as User Equipment (UE) in UMTS terminology) communicates with a serving radio network controller (RNC) 8 via at least one cell 6 of at least one base station 4. In that way, the mobile user terminal communicates with the UTRAN network 2.

### Estimating Speed of Movement

Speed of movement of the mobile terminal 12 is estimated from determining the time interval between handovers from one cell to the next. This approach works because in many areas, such as well-populated areas, coverage by the network is essentially complete. Also, mobile terminals can detect cell changes.

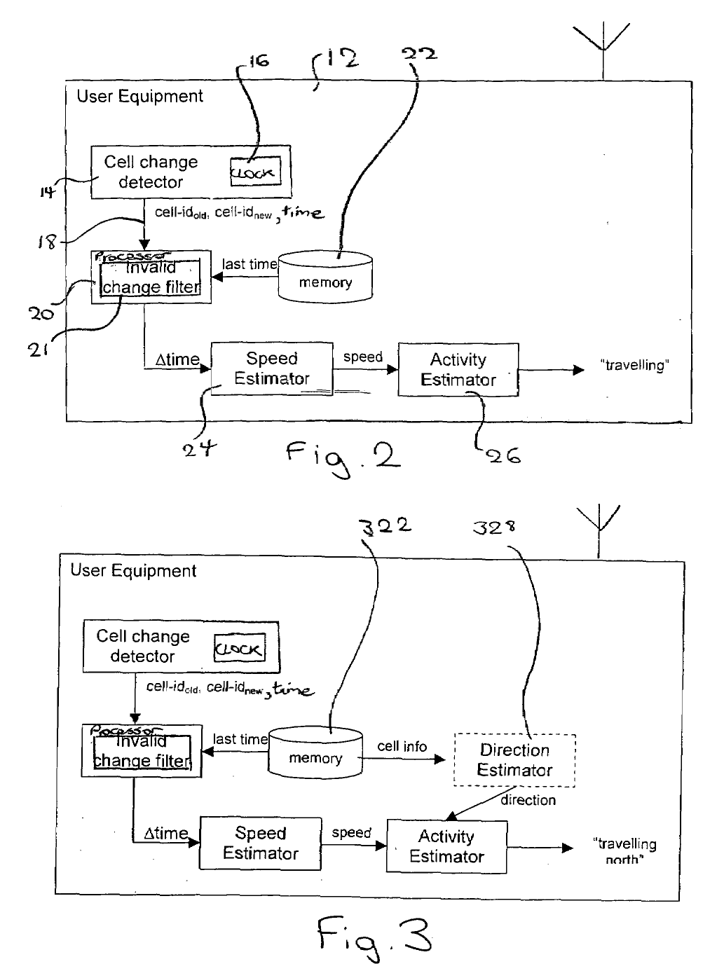

As shown in FIG. 2, an example mobile terminal 12 includes a cell change detector 14. The detector 14 includes an internal clock 16. The detector acts to detect at what time the mobile terminal receives an instruction to handover from one cell to the next, and to send data 18 consisting of the identity of the cell transferred from, cell-id_{old}, the identity of the cell transferred to, cell-id_{new}, and the time T2 of transfer as detected by the clock 16. The data 18 is directed to an invalid change filter 20. The time T1 of last transfer between cells is also provided to the processor 20 from a memory 22 in which that time had been previously stored.

The instruction to handover from one cell to the next is generated by the relevant radio network controller, RNC, 8 as part of so-called network link level signalling. The instruction includes the identity of the cell to be transferred to, cell-id_{new}, and frequency bands to be used.

The processor 20 includes an “invalid change” filter 21 which acts to filter out data of, and so ignore, frequent changes of the form: cell A to cell B to cell A again, as can occur when the mobile terminal is relatively static near to a cell boundary. Otherwise a time interval, Δtime, is deduced where Δtime=T2−T1.

The time interval Δtime is directed to a speed estimator 24. The speed estimator uses an estimate of cell diameter to estimate speed as follows:

Speed=cell diameter/Δtime

The estimated cell diameter is set beforehand dependent on information such as whether the cell is in a rural environment or in a city. In the city, there is higher cell density and hence cell diameter is smaller. Estimated cell diameter is also set dependent on the type of network, for example in this UMTS network, estimated cell diameter is set to be larger than that which would be set for a corresponding network (not shown) of Global System for Mobiles, GSM, type.

### Deriving Context Information from the Speed Estimate

As shown in FIG. 2, the speed estimate from the speed estimator 24 is provided to an activity estimator 26, which acts to select appropriate corresponding context information. Context information is selected for the mobile terminal as follows: for example, at home”, i.e. stationary, when speed is less than 5 kilometres per hour (Km/h); “travelling” when the detected speed is greater than 5 Km/h but less than say, 50 Km/h; and “driving” when the speed is greater than, say, 50 Km/h.

### Sharing Context Information

The context information, once derived, is shared with potential communication parties, for example through the use of the SIP event framework. Specifically, the context information is forwarded to a Presence Server, using a PUBLISH function. From there, the context information can be notified to one or more subscribing interested other users, using NOTIFY functions.

Context information is useful in selecting appropriate enhanced service offerings. For example, context information indicating “driving” might be taken as an indication that the user is a driver and hence an adult in deciding whether to send that user a particular call or message relating to an enhanced service.

### FURTHER EXAMPLES

In a further example (not shown) that is otherwise similar to that shown in FIG. 2, rather than cell size being estimated beforehand dependent merely on rural/city criterion and type of network criterion, more specific knowledge of the size of cells may be used. This knowledge may be due, for example, to test measurements, e.g. of over-air transmission times, or due to information from network planning. This cell size information is stored in the memory of the mobile terminal. Being of greater accuracy, these cell size values should make the speed estimate correspondingly more accurate.

In a further example mobile terminal shown in FIG. 3, which is otherwise similar to the mobile terminal shown in FIG. 2, memory 322 stores information as to the specific geographic location of cells, specifically in terms of longitude and latitude of cell centres. Information of the identity of the cell transferred from, cell_id_{old}, and cell transferred to, cell_id_{new} is passed together with the locations of the centres of those two cells, from the memory 322 to a direction estimator 326. The direction estimator 328 determines a direction of movement, which is used together with the estimated speed of movement to provide an appropriate context e.g. “travelling north” or “driving south-west”.

Specific cell sizes and/or longitude and latitude coordinates can be stored in the memory 322 acting as a database; alternatively if memory 322 is small, that information can be obtained by querying a network-based database (not shown).

The reader will understand that the approaches described above can generally be used in any type of wireless telecommunications network in which cell handovers by mobile terminals can be identified. For example, the approaches described above in relation to FIGS. 2 and 3, to estimating speed of a mobile terminal and hence context information for that mobile terminal, are usable in other networks also, such as GSM networks and WiFi networks.

For example, in a Wi-Fi network, cell handovers are usually mobile-initiated, but timing of cell handovers is nevertheless detectable. Information as to cell identities is provided in the control signals that are broadcast to mobile terminals on a frequency band allocated to a frequency control channel in accordance with an IEEE 802.11 standard, such as 802.11a, 802.11b, or 802.11g. The relevant information as to cell identity is the Access Point Medium Access Control, AP MAC, address (Base Station System IDentity, BSSID).

### GENERAL

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of determining movement context of a mobile user terminal in a wireless telecommunications network by the steps of:
determining a time at which transfer to a first cell occurs,
determining a time at which transfer from said first cell first subsequently occurs,
determining the difference between the two times, and
assigning a movement context to the mobile user terminal, said context being dependent upon said difference.

2. A method according to claim 1, wherein the step of assigning the context dependent upon said difference comprises:
determining an estimate of speed of user terminal movement from an estimate of cell size and the determined difference, and
assigning a context that is dependent on the estimate of speed.

3. A method according to claim 1, wherein the estimate of cell size depends on the type of wireless telecommunications network.

4. A method according to claim 2, wherein the estimate of cell size is known from prior measurement.

5. A method according to claim 1, wherein information of the identities of cells through which the user terminal moves is used to determine an estimate of direction of movement, in said assigning the context to the user, the context also being dependent upon said estimate of direction of movement.

6. A method according to claim 1, wherein the determination of the movement context is automatic determination of the movement context.

7. A mobile user terminal for wireless telecommunications comprising:
a cell change detector operative to provide information of the times at which the mobile user terminal handovers from one cell to another,
a processor operative to determining the difference between times of handovers into then out-of a cell,
a movement context estimator operative to assign a movement context to the mobile user terminal, said context being dependent upon said difference.

8. A mobile user terminal according to claim 7, further comprising a speed estimator operative to determine an estimate of speed of user terminal movement from an estimate of cell size and the determined difference,
the movement context estimator being operative to assign said movement context to the mobile user terminal, said context being dependent upon said estimate of speed of user terminal movement.

9. A mobile user terminal according to claim 7, wherein
a direction estimator is operative to process information of the identities of cells through which the user terminal moves to determine an estimate of direction of movement and to provide said estimate to the movement context estimator,
the movement context estimator is operative to use said estimate of direction of movement in assigning the context to the user, the context being dependent upon said estimate of direction of movement.

10. A mobile user terminal according to claim 7, wherein the processor includes a filter, which filters out data of times of successive handovers into then out-of the cell where those handovers are both into the cell from a first cell then out of the cell to said same first cell, so that the difference between those times is not determined and so not used in assigning movement context.
